(19) United States
(12) Patent Application Publication
(10) Pub. No.: US 2026/0217162 A1
(43) Pub. Date: Jul. 30, 2026

(54) Adjustable Vehicle Seat Unit, and Vehicle

(71) Applicant: Bayerische Motoren Werke Aktiengesellschaft, Muenchen (DE)

(72) Inventors: Ismar COLIC, Muenchen (DE); Thomas GERSTL, Gauting (DE); Andre HARTWIG, Ottobrunn (DE); Florian OBER, Reichersbeuern (DE)

(21) Appl. No.: 19/148,807

(22) PCT Filed: Apr. 3, 2024
(86) PCT No.: PCT/DE2024/100273

§ 371 Date: Jul. 17, 2025

(30) Foreign Application Priority Data
Apr. 6, 2023 (DE) 10 2023 108 925.0

(51) Int. Cl. B60N 2/12; B60N 2/02; B60N 2/16

(52) U.S. Cl. CPC B60N 2/12; B60N 2/0224; B60N 2/163

(57) ABSTRACT

An adjustable vehicle seat unit has a vehicle seat with a seat base and a seat back. A vehicle seat bracket couples the vehicle seat to a vehicle structure. The vehicle seat bracket has a device for longitudinally adjusting a seat and a device, which is functionally coupled to the device for longitudinally adjusting a seat, for adjusting seat inclination. The device for longitudinally adjusting a seat has a first slotted guide system, along which the vehicle seat unit, when displaced in the longitudinal direction of the seat relative to the vehicle structure, is guided in a longitudinally-adjustable and height-adjustable manner. The device for adjusting seat inclination has a second slotted guide system, along which the vehicle seat unit, when displaced in the longitudinal direction of the seat relative to the vehicle structure, is guided in an inclination-adjustable manner.

### BACKGROUND AND SUMMARY

The invention relates to an adjustable vehicle seat unit. It further relates to a vehicle, particularly a motor vehicle, with at least one such adjustable vehicle seat unit.

Vehicle seats, in particular vehicle seats in motor vehicles, are currently formed to be adjustable in a variety of ways, in order to not only primarily be able to set an ergonomically favorable seating position of the driver for operating the vehicle for a variety of different body sizes, but also to secondarily be able to change a variety of seat parameters that influence seat comfort. The adjustment mechanisms and adjustment drives provided for this purpose increase the complexity of a vehicle seat and, above all, its weight and the use of resources during the production of the vehicle seat.

EP 0 099 728 A2 discloses a seat carriage for a vehicle seat forming a seat console, which seat carriage is movable linearly in the longitudinal direction of the vehicle relative to a vehicle structure by means of a lower longitudinal adjustment rail arrangement and is provided with an upper, concavely formed inclination adjustment rail arrangement that supports the vehicle seat. The vehicle seat is formed to be longitudinally displaceable relative to the seat console along the inclination adjustment rail arrangement, which is concave when viewed from above, wherein the vehicle seat is inclined about a transverse axis of the vehicle. The vehicle seat can therefore be adjusted by the driver, on the one hand, with regard to its distance from the pedals and steering wheel along the linearly running seat rail, and additionally, its inclination about a transverse axis of the vehicle can be adjusted by displacing it along the concave inclination adjustment rail arrangement running in a curved manner. However, this lacks a seat height adjustment mechanism to enable the driver's hip point to be optimally positioned ergonomically.

The object of the present invention is to improve the design of such a generic adjustable vehicle seat unit in such a way that the position of the respective hip point of differently built persons sitting on the vehicle seat can be individually and optimally positioned without additional adjustment means.

This object is achieved with the features of the independent claim(s).

An adjustable vehicle seat unit comprising a vehicle seat with a seat base and a seat backrest, and a vehicle seat console provided for coupling the vehicle seat to a vehicle structure, with a seat longitudinal adjustment device and a seat inclination adjustment device functionally coupled thereto is characterized in that the seat longitudinal adjustment device has a first slotted guide along which the vehicle seat unit is guided in a longitudinally adjustable and height-adjustable manner upon displacement in the longitudinal direction of the seat, which normally corresponds to the longitudinal direction of the vehicle, relative to the vehicle structure, and in that the seat inclination adjustment device has a second slotted guide along which the vehicle seat unit is guided in an inclination-adjustable manner upon displacement in the seat longitudinal direction relative to the vehicle seat console.

The longitudinal and height-adjustable displacement of the vehicle seat unit achieved by the provision of the first and second slotted guide and their interaction, coupled with an inclination adjustment of the vehicle seat unit, makes it possible to change the vertical and horizontal position of the hip point simultaneously with a longitudinal adjustment of the vehicle seat. The design of the first and second slotted guides is based on the knowledge that shorter people have shorter legs than taller people and therefore need to be positioned more upright and closer to the steering wheel and the pedals, and that shorter people also have a shorter upper body than taller people and therefore need to sit higher. Therefore, for them, in the most favorable longitudinal position of the vehicle seat for them, the hip point must be higher and the shoulders must be further forward than in the case of taller people. Therefore, the first and second slotted guides are each equipped with a link adapted to this knowledge, wherein these slotted guides run in such a way that, through their interaction, the entire vehicle seat unit is positioned higher and with a steeper backrest position in a forward longitudinal adjustment position than in a rear longitudinal adjustment position. This type of slotted guide also allows for automatic optimization of the seat position with regard to seat inclination and thus also the distance of the upper body of a person sitting on the seat from the steering wheel and the dashboard.

Further preferred and advantageous configuration features of the adjustable vehicle seat unit according to the invention are the subject matter of the dependent claims.

Particularly preferred is an embodiment in which the first slotted guide is non-linear and non-continuously curved. Such a non-linear slotted guide improves the adjustability of the height position automatically approached during a longitudinal seat adjustment of the vehicle seat unit and thus the height of the hip point automatically adjusted depending on the longitudinal position of the seat.

Preferably, the second slotted guide is also non-linear and non-continuously curved.

Preferably, the first slotted guide is formed as an actively driven drive guide and the second slotted guide is formed as a passive drag guide.

In the case of a further advantageous vehicle seat unit according to the invention, which can also be combined with other embodiments of the invention, it is provided that the seat longitudinal adjustment device has a first motor-driven drive device which drive-couples the vehicle seat unit to the vehicle structure and which is formed to guide the vehicle seat unit along the first slotted guide relative to the vehicle structure. The motor-driven drive not only facilitates the operation of the seat longitudinal adjustment, but also enables automatic control of the seat longitudinal adjustment device.

It is also advantageous if the first slotted guide is configured such that the vehicle seat console tilts downward about a third inclination axis running in the transverse direction of the seat when it reaches its foremost position in the direction of travel with its front side facing away from the seat backrest. This allows the vehicle seat arrangement to assume an easy-entry position, for example, in the case of two-door vehicles.

Also advantageous is a further development of the invention which can be combined with other embodiments of the invention, in the case of which a rest seat adjustment device with a third slotted guide is provided, which forms a curved movement path for the vehicle seat relative to the vehicle seat console in order to additionally incline the vehicle seat about a second inclination axis running in the transverse direction of the seat when displaced relative to the vehicle seat console in the longitudinal direction of the seat. This additional inclination adjustment of only the vehicle seat relative to the vehicle seat console allows not only a correction of the position automatically assumed during the longitudinal adjustment of the entire vehicle seat unit, but also the setting of a rest or relaxation position of the vehicle seat. This configuration enables an inclination adjustment of the vehicle seat relative to the vehicle seat console, which is independent of the slotted guide of the entire vehicle seat unit.

It is advantageous if the third slotted guide rail is also continuously curved.

Also advantageous is a further development of the invention which can be combined with other embodiments of the invention, in the case of which the rest seat adjustment device has a second motor-driven drive device which couples the vehicle seat to the vehicle seat console and which is formed to guide the vehicle seat along the third slotted guide relative to the vehicle seat console. Here, too, not only is the usability made easier, but the technical prerequisite for automatic control of the seat inclination is also made possible.

In particular, if both the seat longitudinal adjustment device and the seat inclination adjustment device are provided with a respective motor-driven drive device, in particular a respective electric motor-driven drive device, a joint control device can be provided which is formed to actuate the first drive device and/or the second drive device, preferably in a map-controlled manner, program-controlled manner or memory-controlled manner, so that the vehicle seat can approach a person-specific optimal seat position.

The invention is also directed to a vehicle, particularly a motor vehicle, with at least one adjustable vehicle seat unit according to the invention.

In the case of a vehicle according to the invention, it is particularly advantageous if the control device is formed to control the first drive device and the second drive device such that when the vehicle seat console tilts downward with its front side facing away from the seat back upon reaching its foremost position in the direction of travel, the second drive device associated with the seat inclination adjustment device is actuated such that the seat backrest does not come into contact with a roof of the vehicle. This creates an easy-entry position that allows maximum entry space.

Preferred exemplary embodiments of the invention with additional configuration details and further advantages are described and explained in greater detail below with reference to the attached drawings.

### BRIEF DESCRIPTION OF THE DRAWINGS

FIG. 1 shows an adjustable vehicle seat unit according to an embodiment of the invention with the vehicle seat in a rear, upright position in the side view from the left;

FIG. 2 shows an enlarged schematic representation of a slotted guide of the vehicle seat unit from FIG. 1 forming a seat longitudinal adjustment device;

FIG. 3 shows the vehicle seat unit from FIG. 1 with the vehicle seat in a position in which it is moved forward;

FIG. 4 shows an enlarged schematic representation of the slotted guide of the vehicle seat unit from FIG. 3;

FIG. 5 shows the vehicle seat unit from FIG. 1 with the vehicle seat in the foremost easy-entry position;

FIG. 6 shows an enlarged schematic representation of the slotted guide of the vehicle seat unit from FIG. 5;

FIG. 7 shows a perspective view of a seat base of the adjustable vehicle seat unit according to an embodiment of the invention with a seat inclination adjustment device in the upright position of the vehicle seat;

FIG. 8 shows the perspective view of the seat base from FIG. 7 with the seat inclination adjustment device in a backward inclined position of the vehicle seat and

FIG. 9 shows the vehicle seat unit from FIG. 1 with the vehicle seat in the rear, backward inclined position.

### DETAILED DESCRIPTION OF THE DRAWINGS

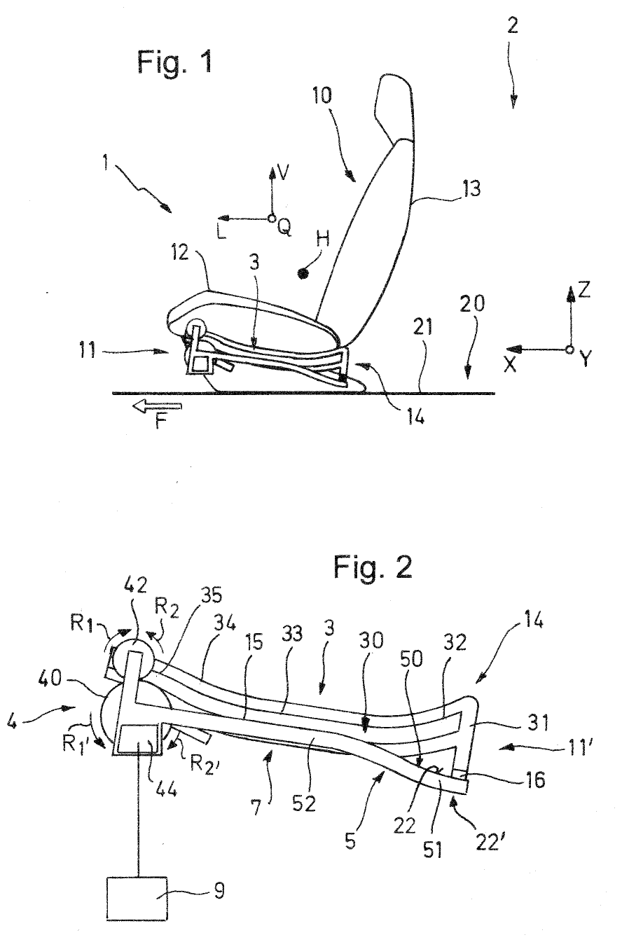

FIG. 1 shows, in a side view from the left, an adjustable vehicle seat unit 1 of a motor vehicle 2 with a vehicle seat 10 in a rearward position with respect to the seat longitudinal direction L, which corresponds, for example, to the longitudinal direction X of the vehicle and thus to the direction of travel F of the motor vehicle 2. The vehicle seat 10 is attached by means of a vehicle seat console 11 to a vehicle interior floor 21 of a vehicle structure 20 of the motor vehicle 2 so as to be displaceable in the longitudinal direction L of the seat, which is only represented schematically in the figures. The vehicle seat 10 has, as a seat structure, a seat base 12 and a seat backrest 13, which are rigidly connected to one another. Seat cushions and seat covers, which are provided on the seat structure in practice, are not represented here. In the representation of FIG. 1, the vehicle seat 10 assumes an upright position with the seat backrest 13 in an upright position.

For the seat longitudinal adjustment of the vehicle seat, the vehicle seat console 11 is provided with a seat longitudinal adjustment device 14, which has a first slotted guide 3 with a first movement path for the vehicle seat 10, which is determined by a slotted guide track 30 of the slotted guide 3. The slotted guide track 30 extends in the longitudinal direction L of the seat and is curved several times in the seat vertical axis direction V of the vehicle seat 10, which essentially corresponds to the vehicle vertical axis direction Z, as can be seen in the enlarged representation of FIG. 2. A rearmost, first portion 31 of the slotted guide track 30 runs predominantly vertically, i.e. with a main directional component in the seat vertical axis direction V. At its upper end, a downward sloping second portion 32 adjoins the front, which further forward merges into a less downward sloping third portion 33.

This is followed by a first rising portion 34 at the front, which further forward merges into a continuously less rising and again slightly downwardly curved portion 35. A guide element, not represented, fixed to the vehicle interacts with the slotted guide track 30 and guides the vehicle seat console 11 and with it the vehicle seat 10 during their displacement in the longitudinal direction X of the vehicle.

In the example shown, a toothing 15, which is formed on the seat base 12, runs parallel to the slotted guide track 30 in the longitudinal direction L of the seat. Such a toothing 15 can be provided on the left and/or right side of the seat base 12.

A first drive unit 4, which is fixed to the vehicle structure and has a lower pinion 40 and an upper pinion 42, which mesh with the toothing 15 and can be driven by a motor-driven drive device 44 controlled by a control device 9, interacts with the toothing 15 on the seat base 12. In a first direction of rotation R1, R1′ of the pinions 40, 42, the seat base 12 and with it the entire vehicle seat 10 are moved forward in the longitudinal direction X of the vehicle, and in a second direction of rotation R2, R2′ of the pinions 40, 42, the seat base 12 and with it the entire vehicle seat 10 are moved rearward in the longitudinal direction X of the vehicle. The vehicle seat 10 moves relative to the vehicle structure 20 not only along the longitudinal direction X of the vehicle, but also along the vehicle vertical axis direction Z, i.e. up and down, depending on the profile of the slotted guide track 30.

At least one sliding block 16 is arranged at the rear lower end 11′ of the vehicle seat console 11, with which sliding block 16 the vehicle seat console 11 is supported at the rear on a slideway 22 fixed to the vehicle, which runs in the longitudinal direction X of the vehicle and forms a slotted guide track 50 of a second slotted guide 5, which guides the vehicle seat console 11 at its rear lower end 11′ and forms a seat inclination adjustment device 7. When the vehicle seat 10 is in the rearmost upright position shown in FIG. 1, the sliding block 16 at the rear lower end 11′ of the vehicle seat console 11 is supported on the rear end 22′ of the slideway 22. The slideway 22 rises from its rear end 22′ forward in a first, steeper slideway-slotted guide portion 51, essentially linearly or with a slight increasing curvature, and then further forward merges into a second slideway portion 52, which is essentially linear and less steeply inclined.

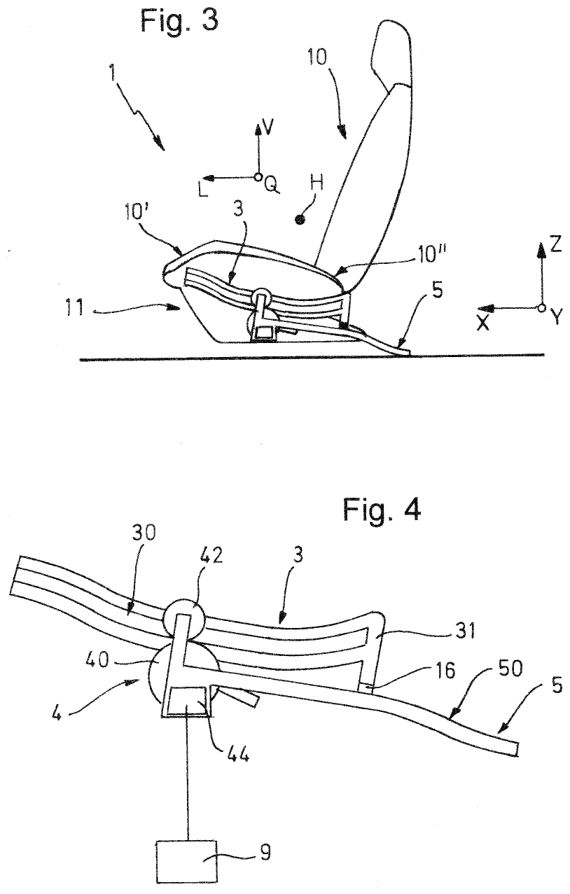

When the vehicle seat 10 is moved forward from the rearmost upright position shown in FIG. 1, for example, into the central longitudinal position shown in FIG. 3, the vehicle seat 10 is raised at the front by the profile of the first slotted guide track 30 and at the rear by the second slotted guide track 50 of the second slotted guide 5. The vertical path traveled by the front vehicle seat region 10′ differs from the vertical path traveled by the rear vehicle seat region 10″, so that the vehicle seat is slightly tilted when moved along the longitudinal direction L of the seat about a first inclination axis that travels with the vehicle seat 10 and runs in the seat transverse direction Q. The inclination direction, i.e. the direction of rotation about the first inclination axis, depends on the respective local profile of the first slotted guide track 30 and the second slotted guide track 50 and their interaction. Preferably, the first inclination axis lies at the hip point H of the vehicle seat.

This slotted guide-controlled profile of the combination of vehicle seat longitudinal position, vehicle seat height position and vehicle seat inclination is based on the knowledge that smaller passengers have shorter legs and arms and therefore need to sit closer to the pedals and closer to the steering wheel as well as higher and more upright than taller passengers.

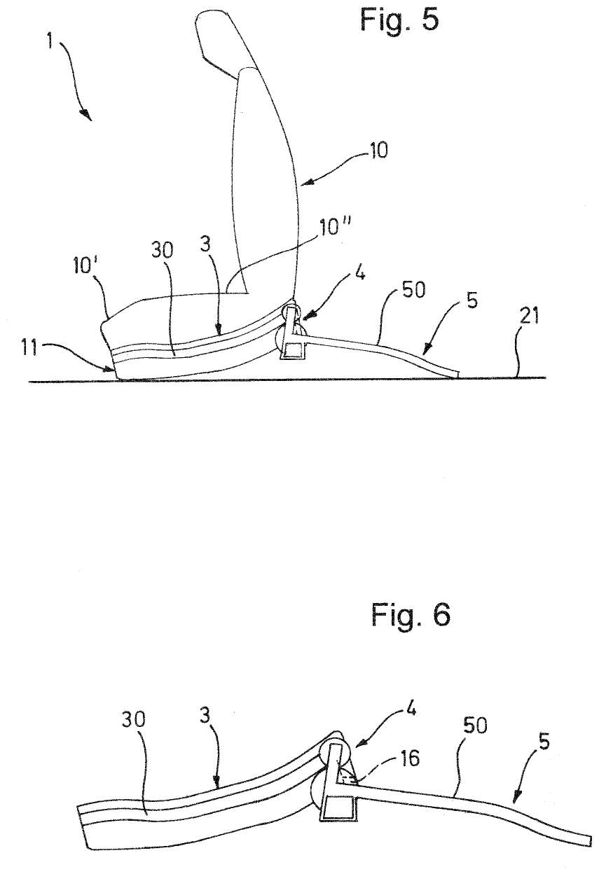

FIG. 5 and FIG. 6 show the vehicle seat 10 in its position where it is moved maximally forward. The sliding block 16 rests on the front end of the second slotted guide track 50 and raises the vehicle seat 10 at the rear.

At the same time, the guide element (not represented) which is fixed to the vehicle and which engages with the first slotted guide track 30, has reached the rear, steeply downwardly sloping first portion 31 of the first slotted guide track 30 and is located at its lower end, as a result of which the front vehicle seat region 10′ is lowered downward toward the vehicle interior floor 21, so that the vehicle seat unit 1 assumes an easy-entry position.

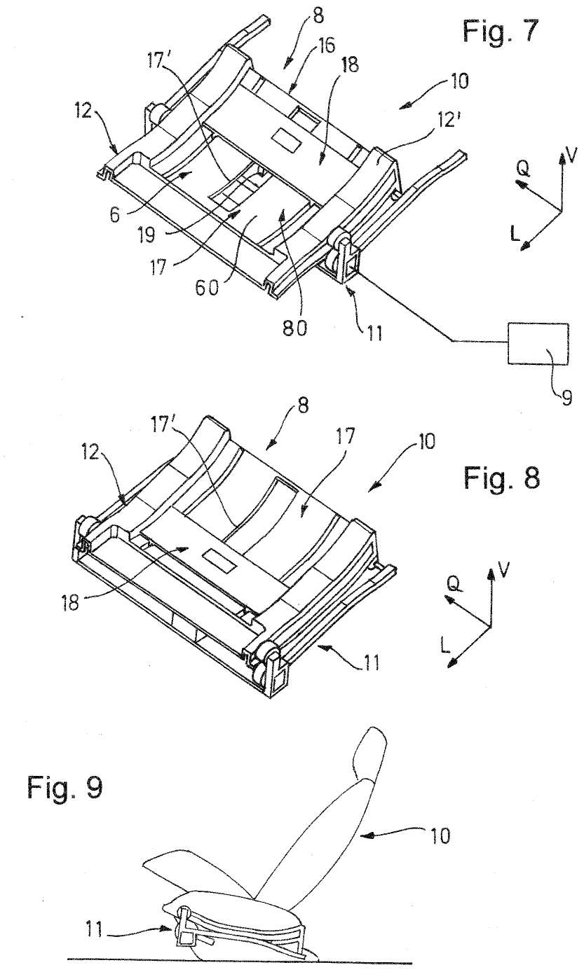

For further adjustment of the inclination of the vehicle seat 10 into a rest position, a rest seat adjustment device 8 is provided, represented in perspective in FIG. 7 and FIG. 8, wherein the rest seat adjustment device 8 has a third slotted guide 6 with a third slotted guide track 60 forming a curved movement path, which forms a concavely curved movement path for the vehicle seat 10, viewed from above, and runs along the longitudinal direction L of the seat. By means of this rest seat adjustment device 8, the vehicle seat 10 is guided with a strong inclination adjustment relative to the vehicle seat console 11.

For this purpose, the seat base 12 of the vehicle seat 10 has, in its central region on its upper side 12′, a trough-like recess 17 curved about a second inclination axis running in the transverse direction Q of the seat and concavely open at the top. An adjustment plate 18 located transversely in the recess 17 is provided with a central guide pin 19, which extends through a longitudinal slot 17′ in the seat base 12 and is connected to the vehicle seat console 11. The lower side of the adjustment plate 18 resting in the recess 17 is provided with the same curvature around the second inclination axis running in the transverse direction Q of the seat as the recess 17, so that the adjustment plate 18 and the seat base 12 provided with the recess 17 can perform a relative movement along a curved movement path 80 in the longitudinal direction L of the vehicle seat, the curvature of which corresponds to the curvature of the third slotted guide 6 determined by the recess curvature. The vehicle seat 10 therefore moves relative to the vehicle seat console 11 along the third slotted guide 6. The third slotted guide 6 is preferably continuously curved and thus determines a circular path around the second inclination axis, about which the vehicle seat 10 can be tilted relative to the vehicle seat console 11 into a rest position shown in FIG. 9 in addition to the combined longitudinal, height, and inclination adjustment shown in FIG. 1 to FIG. 6. The seat base 12 thus formed and provided with the recess 17 and the adjustment plate, together with a second drive device (not shown), form a rest seat adjustment device 8. The second drive device is also controlled by the control device 9.

The invention is not restricted to the above exemplary embodiment, which merely serves to generally explain the core idea of the invention. On the contrary, within the scope of protection, the device according to the invention may also take on embodiments other than those described above. In particular, the device may have in particular features that represent a combination of the respective individual features of the claims.

Reference signs in the claims, the description and the drawings are intended only to facilitate understanding of the invention and are not intended to restrict the scope of protection.

### LIST OF REFERENCE SIGNS

1 Adjustable vehicle seat unit
2 Motor vehicle
3 First slotted guide
4 Operating unit
5 Second slotted guide
6 Third slotted guide
7 Seat inclination adjustment device
8 Rest seat adjustment device
9 Control device
10 Vehicle seat
10′ Front vehicle seat region
10″ Rear vehicle seat region
11 Vehicle seat console
11′ Rear lower end of the vehicle seat console
12 Seat base
12′ Upper side of the seat base
13 Seat backrest
14 Seat longitudinal adjustment device
15 Toothing
16 Sliding block
17 Recess
17′ Longitudinal slot in the seat base
18 Adjustment plate
19 Central guide pin
20 Vehicle structure
21 Vehicle interior floor
22 Slideway fixed to the vehicle
22′ Rear end of the slideway
30 First slotted guide track
31 Rear, first, steeply downward sloping portion
32 Downward sloping, second portion
33 Less downward sloping portion
34 Front, first, rising portion
35 Downwardly curved portion
40 Lower pinion
42 Upper pinion
44 First motor-driven drive device
50 Second slotted guide track
51 First slideway-slotted guide portion
52 Second slideway-slotted guide portion
60 Third slotted guide track
80 Curved movement path
F Direction of travel
H Hip point
L Longitudinal direction of the seat
Q Transverse direction of the seat
R₁, R₁′ First direction of rotation
R₂, R₂′ Second direction of rotation
V Seat vertical axis direction
X Longitudinal direction of the vehicle
Z Vehicle vertical axis direction

1.-12. (canceled)

13. An adjustable vehicle seat unit, comprising:
a vehicle seat with a seat base and a seat backrest; and
a vehicle seat console provided for coupling the vehicle seat to a vehicle structure, the vehicle seat console having a seat longitudinal adjustment device and a seat inclination adjustment device functionally coupled thereto,
wherein the seat longitudinal adjustment device comprises a first slotted guide along which the vehicle seat unit is guided in a longitudinally adjustable and height-adjustable manner upon displacement in a longitudinal direction of the seat relative to the vehicle structure, and
wherein the seat inclination adjustment device comprises a second slotted guide along which the vehicle seat unit is guided in an inclination-adjustable manner upon displacement in the longitudinal direction of the seat relative to the vehicle structure.

14. The adjustable vehicle seat unit according to claim 13, wherein
the first slotted guide is non-linear and non-continuously curved.

15. The adjustable vehicle seat unit according to claim 14, wherein
the second slotted guide is non-linear and non-continuously curved.

16. The adjustable vehicle seat unit according to claim 15, wherein
the first slotted guide is formed as an actively driven drive guide and the second slotted guide is formed as a passive drag guide.

17. The adjustable vehicle seat unit according to claim 13, wherein
the seat longitudinal adjustment device has a first motor-driven drive which drive-couples the vehicle seat unit to the vehicle structure and which is formed to guide the vehicle seat unit along the first slotted guide relative to the vehicle structure.

18. The adjustable vehicle seat unit according to claim 13, wherein
the first slotted guide is configured such that the vehicle seat console tilts downward about a third inclination axis running in a transverse direction of the vehicle seat when the vehicle seat reaches its foremost position in the direction of travel with its front side facing away from the seat backrest.

19. The adjustable vehicle seat unit according to claim 17, further comprising:
a rest seat adjustment device with a third slotted guide which forms a curved movement path for the vehicle seat relative to the vehicle seat console in order to additionally incline the vehicle seat about a second inclination axis running in a transverse direction of the seat when displaced relative to the vehicle seat console in the longitudinal direction of the seat.

20. The adjustable vehicle seat unit according to claim 19, wherein
the third slotted guide is continuously curved.

21. The adjustable vehicle seat unit according to claim 20, wherein
the rest seat adjustment device has a second motor-driven drive which couples the vehicle seat to the vehicle seat console and which is formed to guide the vehicle seat along the third slotted guide relative to the vehicle seat console.

22. The adjustable vehicle seat unit according to claim 21, further comprising:
a control device configured to actuate the first drive and/or the second drive in a map-controlled manner.

23. A vehicle comprising at least one adjustable vehicle seat unit according to claim 13.

24. The vehicle according to claim 23, further comprising:
a control device,
wherein the seat longitudinal adjustment device has a first motor-driven drive which drive-couples the vehicle seat unit to the vehicle structure and which is formed to guide the vehicle seat unit along the first slotted guide relative to the vehicle structure;
a rest seat adjustment device with a third slotted guide which forms a curved movement path for the vehicle seat relative to the vehicle seat console in order to additionally incline the vehicle seat about a second inclination axis running in a transverse direction of the seat when displaced relative to the vehicle seat console in the longitudinal direction of the seat, the rest seat adjustment device having a second motor-driven drive which couples the vehicle seat to the vehicle seat console and which is formed to guide the vehicle seat along the third slotted guide relative to the vehicle seat console,
wherein the control device is configured to control the first drive and the second drive such that when the vehicle seat console tilts downward with its front side facing away from the seat backrest upon reaching its foremost position in the direction of travel, the second drive associated with the seat inclination adjustment device is actuated such that the seat backrest does not come into contact with a roof of the vehicle.
